(19) United States
(12) Patent Application Publication
(10) Pub. No.: US 2026/0067679 A1
(43) Pub. Date: Mar. 5, 2026

(54) AUTHENTICATION FOR DEVICE WITH NON-CELLULAR ACCESS

(71) Applicant: Nokia Technologies Oy, Espoo (FI)

(72) Inventors: Ranganathan MAVUREDDI DHANASEKARAN, Munich (DE); Saurabh KHARE, Bangalore (IN)

(21) Appl. No.: 19/102,037

(22) PCT Filed: Aug. 7, 2023
(86) PCT No.: PCT/IB2023/057966

§ 371 Date: Feb. 7, 2025

(30) Foreign Application Priority Data
Aug. 8, 2022 (IN) 202241045221

(51) Int. Cl. H04W 12/037; H04L 9/08

(52) U.S. Cl. CPC H04W 12/037; H04L 9/0861; H04L 2209/80

(57) ABSTRACT

Example embodiments of the present disclosure relate to authentication for device with non-cellular access. A first apparatus transmits, to a second apparatus, a registration request for a third apparatus. The registration request at least indicates that the third apparatus is accessing a network via a non-cellular mechanism. The first apparatus further receives, from the second apparatus, a first message indicating that the third apparatus is authenticated. Based on the receipt of the first message, the first apparatus further transmits security information to a fourth apparatus for establishing a connection between the third and fourth apparatuses. In this way, the third apparatus can be authenticated. In addition, secure connection can be established between the third and fourth apparatuses.

### FIELD

Various example embodiments of the present disclosure generally relate to the field of telecommunication and in particular, to methods, devices, apparatuses and computer readable storage medium for authentication for device with non-cellular access.

### BACKGROUND

With the rapid development of the communication technology, communication systems can support various types of access technologies for terminal devices. For example, the terminal device may connect to a communication network via a cellular access mechanism such as a 3^{rd} generation partnership project (3GPP) access mechanism. Alternatively, in some scenarios, the terminal device may connect to the communication network via a non-cellular access mechanism such as a non-3GPP access mechanism. In recent communication technologies, it has been proposed that the terminal device accessing the network via the non-cellular mechanism needs to be authenticated or registered with the network prior to performing communications. Such authentication or registration process may ensure the security of data communication. Works are ongoing to introduce the authentication for device with non-cellular access.

### SUMMARY

In a first aspect of the present disclosure, there is provided a first apparatus. The first apparatus comprises at least one processor; and at least one memory storing instructions that, when executed by the at least one processor, cause the first apparatus at least to perform: transmitting, to a second apparatus, a registration request for a third apparatus, the registration request at least indicating that the third apparatus is accessing a network via a non-cellular mechanism; receiving, from the second apparatus, a first message indicating that the third apparatus is authenticated; and based on the receipt of the first message, transmitting security information to a fourth apparatus for establishing a connection between the third and fourth apparatuses.

In a second aspect of the present disclosure, there is provided a second apparatus. The second apparatus comprises at least one processor; and at least one memory storing instructions that, when executed by the at least one processor, cause the second apparatus at least to perform: receiving, from a first apparatus, receiving, from a first apparatus, a registration request for a third apparatus, the registration request at least that the third apparatus is accessing a network via a non-cellular mechanism; transmitting, to a fifth apparatus, an authentication request for the third apparatus, the authentication request at least indicating that the third apparatus is accessing the network via the non-cellular mechanism; and transmitting, to the first apparatus, a first message to indicate that the third apparatus is authenticated.

In a third aspect of the present disclosure, there is provided a third apparatus. The third apparatus comprises at least one processor; and at least one memory storing instructions that, when executed by the at least one processor, cause the third apparatus at least to perform: transmitting, to at least one of a first or fourth apparatus, a message at least indicating that the third apparatus is accessing a network via a non-cellular mechanism: determining security information for establishing a connection between the third and fourth apparatuses; and performing, based on the security information, a procedure with the fourth apparatus to establish the connection.

In a fourth aspect of the present disclosure, there is provided a fourth apparatus. The fourth apparatus comprises at least one processor; and at least one memory storing instructions that, when executed by the at least one processor, cause the fourth apparatus at least to perform: receiving, from a first apparatus, security information for establishing a connection between a third apparatus and the fourth apparatus; and performing, based on the security information, a procedure with the third apparatus to establish the connection.

In a fifth aspect of the present disclosure, there is provided a fifth apparatus. The fifth apparatus comprises at least one processor; and at least one memory storing instructions that, when executed by the at least one processor, cause the fifth apparatus at least to perform: receiving, from a second apparatus, a first authentication request for a third apparatus, the first authentication request at least indicating that the third apparatus is accessing a network via a non-cellular mechanism; and transmitting, to a sixth apparatus, a second authentication request for the third apparatus.

In a sixth aspect of the present disclosure, there is provided a method. The method comprises: transmitting, from a first apparatus to a second apparatus, a registration request for a third apparatus, the registration request at least indicating that the third apparatus is accessing a network via a non-cellular mechanism: receiving, from the second apparatus, a first message indicating that the third apparatus is authenticated; and based on the receipt of the first message, transmitting security information to a fourth apparatus for establishing a connection between the third and fourth apparatuses.

In a seventh aspect of the present disclosure, there is provided a method. The method comprises: receiving, by a second apparatus from a first apparatus, a registration request for a third apparatus, the registration request at least that the third apparatus is accessing a network via a non-cellular mechanism: transmitting, to a fifth apparatus, an authentication request for the third apparatus, the authentication request at least indicating that the third apparatus is accessing the network via the non-cellular mechanism; and transmitting, to the first apparatus, a first message to indicate that the third apparatus is authenticated.

In an eighth aspect of the present disclosure, there is provided a method. The method comprises: transmitting, from a third apparatus to at least one of a first or fourth apparatus, a message at least indicating that the third apparatus is accessing a network via a non-cellular mechanism: determining security information for establishing a connection between the third and fourth apparatuses; and performing, based on the security information, a procedure with the fourth apparatus to establish the connection.

In a ninth aspect of the present disclosure, there is provided a method. The method comprises: receiving, by a fourth apparatus and from a first apparatus, security information for establishing a connection between a third apparatus and the fourth apparatus; and performing, based on the security information, a procedure with the third apparatus to establish the connection.

In a tenth aspect of the present disclosure, there is provided a method. The method comprises: receiving, by a fifth apparatus from a second apparatus, a first authentication request for a third apparatus, the first authentication request at least indicating that the third apparatus is accessing a network via a non-cellular mechanism; and transmitting, to a sixth apparatus, a second authentication request for the third apparatus.

In an eleventh aspect of the present disclosure, there is provided a computer readable medium. The computer readable medium comprises instructions stored thereon for causing an apparatus to perform at least the method according to the sixth aspect, the seventh aspect, the eighth aspect, the ninth aspect, or the tenth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for authenticating a device according to some example embodiments of the present disclosure;

FIG. 3 illustrates another signaling chart for authenticating a device according to some example embodiments of the present disclosure:

FIG. 4 illustrates a flowchart of a method implemented at a first apparatus according to some example embodiments of the present disclosure:

FIG. 5 illustrates a flowchart of a method implemented at a second apparatus according to some example embodiments of the present disclosure:

FIG. 6 illustrates a flowchart of a method implemented at a third apparatus according to some example embodiments of the present disclosure:

FIG. 7 illustrates a flowchart of a method implemented at a fourth apparatus according to some example embodiments of the present disclosure:

FIG. 8 illustrates a flowchart of a method implemented at a fifth apparatus according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

### Example Environment

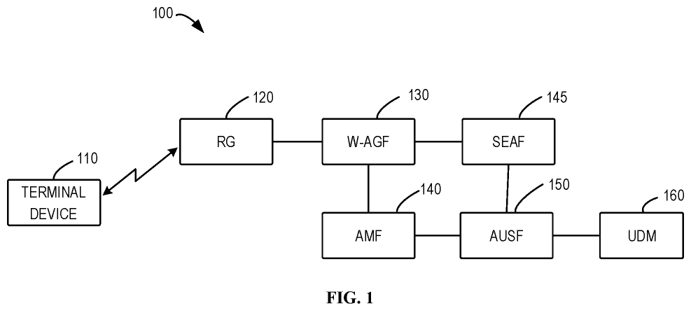

FIG. 1 illustrates an example communication environment 100 in which example embodiments of the present disclosure can be implemented. In the communication environment 100, a terminal device 110 gets access to a communication network, such as a 5G Core (5GC) network or any other suitable networks. The communication environment 100 may support different types of access technology, such as cellular access or non-cellular access.

The terminal device 110 may access the communication network via a non-cellular mechanism or non-cellular access. As used herein, a terminal device accessing the communication network via the non-cellular mechanism may be referred to as non-cellular device or device with non-cellular access. The non-cellular access may include non-3GPP access. The terminal device 110 with non-3GPP access may use non-3GPP access technology to connect to the communication network but not support non access stratum (NAS) over the non-3GPP access. Such a terminal device may be referred to as a non-3GPP device or a device with non-3GPP access. It is to be understood that the terminal device 110 may also support cellular access or 3GPP access in some situations. Unless explicitly stated, in some example embodiments the terminal device 110 accesses the communication network via the non-cellular mechanism.

In some example embodiments, the non-3GPP device may include an authenticable non-3GPP (AUN3) device. As used herein, the term of “AUN3 device” may refer to a device which the communication network such as the 5GC network can authenticate or identified. The AUN3 device may not support NAS over non-3GPP access, but may possesses network credentials, such as 5G credentials or other suitable credentials. For example, a universal subscriber identity module (USIM) may be present for the AUN3 device, but the protocol stack or the NAS may not be present for the AUN3 device. In some example embodiments, the AUN3 device may support network authentication method such as 5GC authentication method. Alternatively, or in addition, the AUN3 device may have a subscription with the network such as the 5GC network.

The terminal device 110 may get access to the communication network via a network device such as a residential gateway (RG) 120 (also referred to as a Wireless Local Area Network (WLAN) Access Point (AP)), or any other suitable network device. For example, the terminal device 110 may access the communication network by connecting the RG 120 via WLAN or wireline. The terminal device 110 using non-3GPP mechanism or the non-3GPP device may use the non-3GPP access technology to connect to the RG 120 but not support NAS over the non-3GPP access.

The communication environment 100 includes a wireline access gateway function (W-AGF) 130 connected to the RG 120. The RG 120 may connect to the communication network via 3GPP access or via the W-AGF 130. The communication environment 100 may also include an access and mobility management function (AMF) 140 and a security anchor function (SEAF) 145 both connected to the W-AGF 130, an authentication server function (AUSF) 150 connected to the AMF 140 and SEAF 145, and a unified data management (UDM) 160 connected to the AUSF 150.

The AMF 140 may provide registration and connecting management, and other suitable functions. For example, the AMF 140 may provide support of authentication of the terminal device 110. The SEAF 145 may also provide support of authentication of the terminal device 110. The AUSF 150 may provide the authentication server function and other suitable functions. The UDM 160 may provide support for generation of authentication credentials, subscription management, and other suitable functions.

It is to be understood that the number of devices and their connections shown in FIG. 1 are only for the purpose of illustration without suggesting any limitation. The communication environment 100 may include any suitable number of devices to implement example embodiments of the present disclosure. Although not shown, it would be appreciated that one or more additional devices may be located in the communication environment 100, and one or more additional devices may connect to the communication environment 100. It is to be understood that in some example embodiments, the communication environment 100 may include more or less devices or apparatuses. For example, the communication environment 100 may not include the AMF 140 or the SEAF 145.

It is also to be understood that the example communication environment 100 is shown only for purpose of illustration, without suggesting any limitation to the scope of the present disclosure. Embodiments of the present disclosure may also be applied to a communication environment with a different structure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mentioned above, a terminal device may connect to a communication network via a non-cellular mechanism such as a non-3GPP access mechanism. To ensure the security of data communications of such terminal device, an authentication or registration process needs to be performed for the terminal device.

In some solutions, it has proposed to address differentiated services (such as quality of service or charging) for various types of non-3GPP devices and terminal devices connected behand a 5G RG. In some other solutions, it has proposed to authenticate non-5G capable (N5GC) device. However, such N5GC authentication process only considers wireline devices connecting to the RG using Ethernet, but cannot cover non-3GPP devices such as AUN3 devices. The authentication or authorization of the non-3GPP devices has not been solved yet.

### Work Principle and Example Signaling for Communication

As discussed above, it is challenging to authenticate the device with non-cellular access. According to example embodiments of the present disclosure, there is provided a solution for authentication of device with non-cellular access. In this solution, a first apparatus transmits, to a second apparatus, a registration request for a third apparatus. The registration request indicates that the third apparatus is accessing a network via a non-cellular mechanism. That is, the registration request indicates that the third apparatus is an apparatus with non-cellular access. The first apparatus receives a message indicating that the third apparatus is authenticated from the second apparatus. With the receipt of the message, the first apparatus transmits security information to a fourth apparatus for establishing a connection between the third and fourth apparatuses.

In this way, the third apparatus can be authenticated. Secure connection between the third apparatus and the network can be established. Security for both the third apparatus and the network can be ensured.

Example embodiments of the present disclosure will be described in detail below with reference to the accompanying drawings.

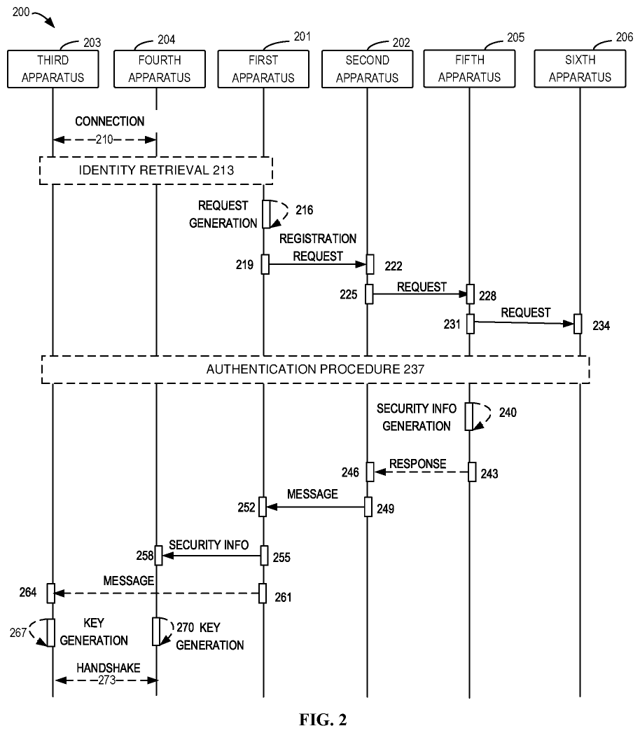

FIG. 2 shows a signaling chart 200 for authenticating a device according to some example embodiments of the present disclosure. As shown in FIG. 2, the signaling chart 200 involves a first apparatus 201, a second apparatus 202, a third apparatus 203, a fourth apparatus 204, a fifth apparatus 205 and a sixth apparatus 206. In some example embodiments, the first apparatus 201 may be the W-AGF 130 in FIG. 1, the second apparatus 202 may be the AMF 140 or the SEAF 145 in FIG. 1, the third apparatus 203 may be the terminal device 110 in FIG. 1, the fourth apparatus 204 may be the RG 120 in FIG. 1, the fifth apparatus 205 may be the AUSF 150 in FIG. 1, and the sixth apparatus 206 may be the UDM 160 in FIG. 1.

Although one first apparatus 201, one second apparatus 202, one third apparatus 203, one fourth apparatus 204, one fifth apparatus 205 and one sixth apparatus 206 are illustrated in FIG. 2, it would be appreciated that there may be a plurality of apparatuses performing similar operations as described with respect to the first apparatus 201, the second apparatus 202, the third apparatus 203, the fourth apparatus 204, the fifth apparatus 205 or the sixth apparatus 206 below.

In operation, a connection may be established (210) between the third apparatus 203 and the fourth apparatus 204. For example, a WLAN connection may be established (210) between the third apparatus 203 and the WLAN access network (AN) by using IEEE 802.11 or other suitable procedure. For another example, a wireline connection may be established (210) between the third apparatus 203 and the fourth apparatus 204.

In some example embodiments, an identity retrieval process 213 may be performed between the third apparatus 203, the fourth apparatus 204 and the first apparatus 201. For example, a message with the identity of the third apparatus 203 (referred to as an identity message) may be transmitted to the fourth apparatus 204 and the first apparatus 201. Alternatively, in some example embodiments, the identity message with identity of the third apparatus 203 may be transmitted by the third apparatus 203 to the fourth apparatus 204. The fourth apparatus 204 may forward the identity message to the first apparatus 201.

The identity message or the identity of the third apparatus 203 may at least indicate that the third apparatus 203 is accessing the network via a non-cellular mechanism. For example, the identity of the third apparatus 203 may indicating an apparatus type of the third apparatus 203. The apparatus type indicates an associated access type of the non-cellular mechanism used by the third apparatus 203. That is, the apparatus type may indicate the non-cellular mechanism.

The apparatus type may include a non-cellular apparatus type, a non-3GPP device type, an AUN3 device type, or any other suitable type. For example, the apparatus type of the third apparatus 203 being a non-cellular type may indicate that an access type of the third apparatus 203 is non-cellular access. In other words, the non-cellular access type is associated with the non-cellular mechanism. That is, the third apparatus 203 is accessing the network via the non-cellular mechanism.

Likewise, the apparatus type of the third apparatus 203 being a non-3GPP type or an AUN3 type may indicate that an access type of the third apparatus 203 is non-3GPP access without NAS. In other words, the non-3GPP access without NAS type is associated with the non-3GPP without NAS mechanism. That is, the third apparatus 203 is accessing the network via the non-3GPP mechanism without NAS.

In some example embodiments, the identity of the third apparatus 203 may be in a network access identifier (NAI) format, such as “username@realm” or the like. In other words, the identity message may include the NAI of the third apparatus 203 in the form of “username@realm” or the like. It is to be understood that the above example name in the NAI format is only for the purpose of illustration, without suggesting any limitation. Any other suitable format may also be applied.

In some example embodiments, the identity message of the third apparatus may further include an identification of the third apparatus 203, such as a subscription permanent identifier (SUPI) of the third apparatus 203. Alternatively, the identification of the third apparatus 203 may include a subscription concealed identifier (SUCI), an identifier in NAI format such as a SUCI in NAI format, or an identifier in global unique temporary identifier such as a 5G-GUTI.

Alternatively, or in addition, in some example embodiments, a layer 2 (L2) connection between the third apparatus 203, the fourth apparatus 204 and the first apparatus 201 may be established. The L2 connection or L2 data link may support an extensible authentication protocol (EAP) encapsulation. An EAP identity retrieval process may be performed via the L2 connection. For example, the first apparatus 201 may transmit an EAP identity request to the third apparatus 203. Based on the receipt of the EAP identity request, the third apparatus 203 may transmit an EAP response or EAP message with its identity to the first apparatus 201 and the fourth apparatus 204. The EAP request, EAP response or EAP message may be encapsulated inside an L2 frame such as EAP over line (EAPOL). Example messages, requests or responses described hereinafter may also be encapsulated inside the L2 frame such as the EAPOL. It is to be understood that the identity retrieval process 213 with EAP request and response is only for the purpose of illustration, without suggesting any limitations. Any suitable identity retrieval process 213 may be applied.

Based on the identity of the third apparatus 203, the first apparatus 201 may generate (216) a registration request for the third apparatus 203. For example, the first apparatus 201 may generate (216) the registration request on behalf of the third apparatus 203 based on the received identity message. The generated registration request at least indicates that the third apparatus 203 is accessing the network via the non-cellular mechanism.

By indicating the non-cellular mechanism in the registration request, the non-cellular apparatus such as the AUN3 device may be identified by other apparatuses. In this way, other apparatuses may distinguish the non-cellular apparatus from other apparatuses such as 3GPP apparatuses. Thus, other apparatus may realize the need for authentication for the apparatuses such as AUN3 devices.

In some example embodiments, the registration request may include an indication of a requirement for an encryption key for the third apparatus 203. Alternatively, or in addition, the registration request may include an indication of an apparatus type of the third apparatus 203. For example, the indication of the requirement for an encryption key may include a flag for of AUN3 device encryption required indication. The flag may indicate that the third apparatus 203 is an AUN3 device (that is, the third apparatus 203 is accessing the network via a non-3GPP mechanism without NAS) and encryption required indication for the third apparatus is true. The flag may also indicate that the registration request is on behalf of an AUN3 device, and protection is needed for the interface between the AUN3 device (which is the third apparatus 203) and the fourth apparatus 204. In other words, the flag may indicate that an AUN3 device is requesting for encryption information or security information.

The indication of the apparatus type may include an express indication such as a field of “AUN3 device” or the like. The indication of the apparatus type may be in the NAI format. For example, the indication may be NAI with “AUN3” information, such as “<5G_device_unique_identity>@nai.aun3.5gc-nn.mnc<MNC>.mcc<MCC>0.3gppnetwork.org”, “<5G_device_unique_identity>@5gc.aun3.mnc<MNC>.mcc<MCC>0.3gppnetwork.org” or the like. The indication of the apparatus type may indicate that the third apparatus 203 is an AUN3 device. That is, an AUN3 device which access the network via a non-3GPP mechanism without NAS is requesting for the registration.

Alternatively, or in addition, in some example embodiments, the registration request may indicate an identification of the third apparatus 203. For example, in the example where the received identity of the third apparatus includes the identification such as the SUPI of the third apparatus 203, the registration request may include a SUCI of the third apparatus 203. The SUCI may be generated by the first apparatus 201 based on the SUPI by using a NULL scheme.

In some example embodiments, the registration request may further include wireline network name such as serving network name (SN-name) if available. An example registration request may include Registration Request (SUCI, SN-name, flag for AUN3 device encryption required indication). It is to be understood that the above example is only for the purpose of illustration, without suggesting any limitations. Any other suitable information may be included in the registration request.

In some example embodiments, the first apparatus 201 may perform additional actions, such as selecting the second apparatus 202. For example, the first apparatus 201 may select the AMF 140 or SEAF 145 in FIG. 1 as the second apparatus 202. The first apparatus 201 may use any suitable method to select the second apparatus 202.

The first apparatus 201 transmits (219) the registration request for the third apparatus 203 to the second apparatus 202. The second apparatus 202 receives (222) the registration request. The second apparatus 202 transmits (225) a first authentication request for the third apparatus 203 to a fifth apparatus 205. The first authentication request at least indicates that the third apparatus is accessing a network via a non-cellular mechanism. The first authentication request may further include other information, such as the identification of the third apparatus 203 or other information included in the registration request.

In the example where the registration request includes Registration Request (SUCI, SN-name, flag for AUN3 device encryption required indication), an example of first authentication request may include: Nausf_UEAuthentication_AuthenticateRequest (SUCI, SN-name, flag for AUN3 device encryption required indication). It is to be understood that the above example of first authentication request is only for the purpose of illustration, without suggesting any limitations.

The fifth apparatus 205 receives (228) the first authentication request. The fifth apparatus 205 transmits (231) a second authentication request for the third apparatus 203 to a sixth apparatus 206. The second authentication may be similar to the first authentication. In some example embodiments, the content in the first and second authentication request may be the same. Alternatively, the second authentication may not indicate the non-cellular mechanism used by the third apparatus 203.

In some example embodiments, the second authentication request may indicate that a session key is needed by the third apparatus 203. In the example where the first authentication request includes Nausf_UEAuthentication_AuthenticateRequest (SUCI, SN-name, flag for AUN3 device encryption required indication), the second authentication request may include Nudm_UEAuthentication_AuthenticateRequest (SUCI, SN-name, optional flag for AUN3 device encryption required indication).

It is to be understood that the above examples for the first and second authentication request are only for the purpose of illustration, without suggesting any limitations. Any other suitable authentication requests may be applied.

The sixth apparatus 206 receives (234) the second authentication request for the third apparatus 203 from the fifth apparatus 205. In some example embodiments, the sixth apparatus 206 may initiate an authentication procedure 237 for the third apparatus 203. For example, the sixth apparatus 206 may perform a de-concealment for the SUCI included in the second authentication request to obtain SUPI for the third apparatus 203. In addition, the sixth apparatus 206 may perform an authentication selection, such as selecting the authentication procedure 237 based on the second authentication request. The sixth apparatus 206 may initiate the selected authentication procedure 237. Any suitable selection method may be used by the sixth apparatus. The scope of the present disclosure will not be limited in this regard.

In some example embodiments, the authentication procedure 237 may include an EAP-transport level security (EAP-TLS) authentication procedure or also referred to as the authentication procedure 237 for EAP-TLS. Any suitable EAP-TLS authentication procedure may be applied. Alternatively, or in addition, other authentication procedure may also be applied, which will be described below.

Taking the EAP-TLS authentication procedure as an example, if the authentication procedure is success, the fifth apparatus 205 may determine that the third apparatus 203 is authenticated based on the authentication procedure 237 initiated by the sixth apparatus 206. In such scenario, the fifth apparatus 205 may transmit (243) an authentication response to the second apparatus 202. In some example embodiments, the authentication response may indicate that the third apparatus 203 is authenticated.

Alternatively, or in addition, the authentication response may include security information for the third apparatus 203. In the example where the authentication response includes the security information, the fifth apparatus 205 may generate (240) the security information based on a credential for the third apparatus 203, such as an EAP credential for the AUN3 device.

In some example embodiments, the security information may include a session key for the third apparatus, such as a master session key (MSK), an extended master session key (EMSK) or the like. It is to be understood that although the generating (240) of the security information is shown after the authentication procedure 237, in some example embodiments, the security information generation may be performed before the authentication procedure 237, or during the authentication procedure 237.

An example authentication response including the security information may include Nausf_UEAuthentication_AuthenticateResponse (EAP-Success, EMSK). It is to be understood that the above example authentication response is only for the purpose of illustration, without suggesting any limitations. Any other suitable authentication response may be applied.

The second apparatus 202 may receive (246) the authentication response. The second apparatus 202 transmits (249), to the first apparatus 201, a first message to indicate that the third apparatus 203 is authenticated. For example, the second apparatus 202 may transmit (249) the first message based on the receipt of the authentication response. Alternatively, in some example embodiments, the second apparatus may transmit (249) the first message under other conditions. The first apparatus 201 receives (252) the first message.

In the example where the authentication response includes the security information for the third apparatus 203, the first message may include the security information. In the example where the authentication response includes Nausf_UEAuthentication_AuthenticateResponse (EAP-Success, EMSK), the first message may include Authentication_Result (EAP-Success, EMSK). It is to be understood that the above example first message is only for the purpose of illustration, without suggesting any limitations. Any other suitable first message may be applied.

The first apparatus 201 transmits (255) the security information for the third apparatus 203 to the fourth apparatus 204 to establish a connection between the third apparatus 203 and the fourth apparatus 204. In such cases, the fourth apparatus receives (258) the security information. Examples of security information have been described above, which will not be repeated here.

In some example embodiments, the first apparatus 201 may transmit (261) a second message to the third apparatus 203 to indicate that the third apparatus 202 is authenticated. For example, the first apparatus 201 may transmit (261) an EAP-Success message to the third apparatus 203 via L2 connection. The third apparatus 203 may receive (264) the second message.

The third apparatus 203 may generate (267) a key for communicating with the fourth apparatus. Likewise, the fourth apparatus 204 may generate (270) a same key for communicating with the third apparatus 203. For example, the key may include a WLAN key. In some example embodiments, the third apparatus 203 may generate (267) the key such as the WLAN key based on a credential for the third apparatus 203. For example, based on the receipt (264) of the second message, the third apparatus 203 may generate (267) the key such as the WLAN key based on the credential. In some example embodiments, the fourth apparatus 204 may generate (270) the key such as the WLAN key based on the received (258) security information.

In some solutions, it is proposed to establish a connection between the terminal device and the network node by using the network node's slice information. However, such solutions will expose the network node's slice information to the terminal device. It would pose a security threat to the network or the company that owns slice. How to select the trusted non-3GPP gateway function (TNGF) or non-3GPP interworking function (N3IWF) that supports single network slice selection assistance information (S-NASSAI(s)) requested by the terminal device during authentication or registration via a non-3GPP access network is still a concerning problem.

In some example embodiments according to the present disclosure, the third apparatus 203 and the fourth apparatus 204 perform a procedure with each other to establish the connection based on the security information described above. Details regarding the establish of the connection may be described below.

In some example embodiments, the third apparatus 203 and the fourth apparatus 204 perform a procedure with each other to establish the connection based on the security information. The procedure may include a handshake procedure 273. For example, the third apparatus 203 and the fourth apparatus 204 may perform the handshake procedure 273 using the security information such as the EMSK. The handshake procedure 273 may include a 4-way handshake procedure. By performing the handshake procedure 273, the third apparatus can establish a secure connection with the WLAN AP (for example, the RG).

By using the present connection establishing process shown in the signaling chart 200, the network node's slice information may not be used in the authentication of the apparatus with non-cellular access. For example, the third apparatus may use the security information to generate the WLAN key for establishing the connection. The security information may be generated based on the credential for the third apparatus. Therefore, the network node's slice information may be protected. The network and the company owning the slice will be protected.

Example embodiments regarding authentication for the apparatus using non-cellular mechanism have been described with respect to FIG. 2. With such authentication for the apparatus, the apparatus with non-cellular access such as the AUN3 device behind the RG connecting to the network can be identified, authorized and authenticated. In this way, security connection may be established, thus the communication security may be protected.

In the example of FIG. 2, the EAP-TLS authentication procedure is used as an example of the authentication procedure. Alternatively, or in addition, other types of authentication procedures may be applied.

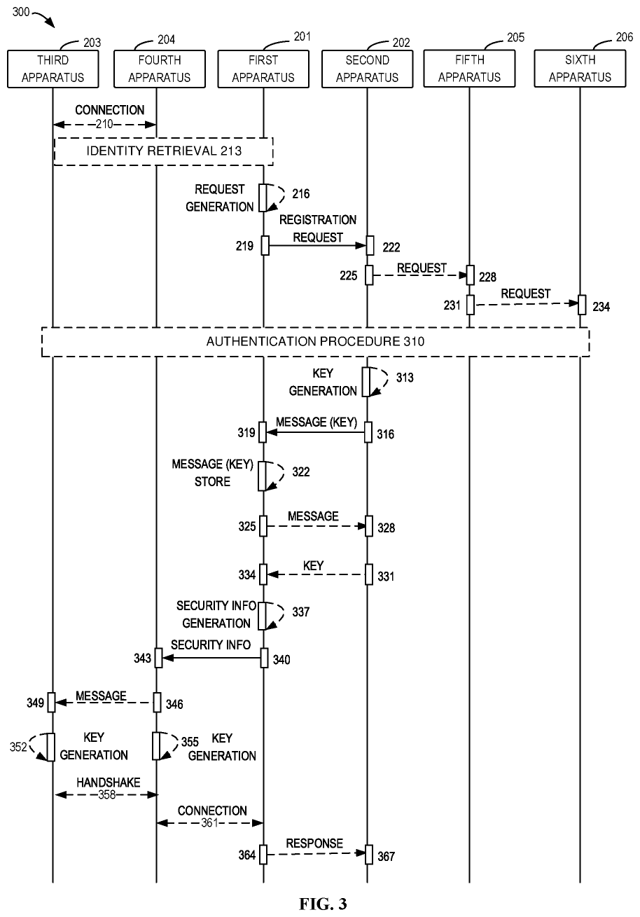

FIG. 3 illustrates another signaling chart 300 for authenticating an apparatus according to some example embodiments of the present disclosure. In the signaling chart 300, an authentication procedure 310 different from the authentication procedure 237 in FIG. 2 may be applied, which is be described below. As shown in FIG. 3, similar to the signaling chart 200, the signaling chart 300 involves the first apparatus 201, the second apparatus 202, the third apparatus 203, the fourth apparatus 204, the fifth apparatus 205 and the sixth apparatus 206.

In some example embodiments, the first apparatus 201 may be the W-AGF 130 in FIG. 1, the second apparatus 202 may be the AMF 140 or the SEAF 145 in FIG. 1, the third apparatus 203 may be the terminal device 110 in FIG. 1, the fourth apparatus 204 may be the RG 120 in FIG. 1, the fifth apparatus 205 may be the AUSF 150 in FIG. 1, and the sixth apparatus 206 may be the UDM 160 in FIG. 1.

Although one first apparatus 201, one second apparatus 202, one third apparatus 203, one fourth apparatus 204, one fifth apparatus 205 and one sixth apparatus 206 are illustrated in FIG. 3, it would be appreciated that there may be a plurality of apparatuses performing similar operations as described with respect to the first apparatus 201, the second apparatus 202, the third apparatus 203, the fourth apparatus 204, the fifth apparatus 205 or the sixth apparatus 206 below.

In operation, the apparatuses involved in the signaling chart may perform similar processes or actions before the authentication procedure 310 for the third apparatus 203. For the purpose of illustration, those similar processes or actions illustrated with same reference number will not be repeated here. In the signaling chart 300, the sixth apparatus 206 may select the authentication procedure 310 different from the authentication procedure 237. The sixth apparatus 206 may initiate the authentication procedure 310.

In some example embodiments, the authentication procedure 310 may include an extensible authentication protocol-authentication and key agreement (EAP-AKA) procedure, an improved EAP-AKA (EAP-AKA′) procedure, or a 5G authentication and key agreement (5G AKA) procedure. Any suitable EAP-AKA, EAP-AKA′ or 5G AKA procedure may be applied.

In some example embodiments, the second apparatus 202 may generate (313) a first key for the first apparatus 201. For example, the second apparatus 202 may generate (313) at least in part based on an access type associated with the non-cellular mechanism used by the third apparatus 203. In some example embodiments, the second apparatus 202 may obtain the associated access type of the third apparatus 203 based on the received (222) registration request. In some example embodiments, the second apparatus 202 may generate (313) the first key (referred to as KWAGF) based on a key (referred to as KAMF) for the second apparatus 202 itself and the associated access type of the third apparatus 203.

In some example embodiments, the second apparatus 202 may use a key derivation function (KDF) to generate (313) the first key KWAGF. The second apparatus 202 may input the following parameters in the input S to the KDF:

$$FC = 0 x 6 E or 0 x 〈 to be defined 〉 ;$$

$$P 1 = Access type distinguisher ;$$

$$L 1 = length of Access type distinguisher ( i . e . , 0 x 00 , 0 x 01 ) .$$

In some example embodiments, the value for access type distinguishers of different apparatuses may be determined based on a predetermined table, for example Table 1 below.

TABLE 1
example access type distinguishers

| access type distinguisher | value |
|---|---|
| 3GPP | 0x01 |
| non-3GPP access | 0x02 |
| Non-3GPP access without NAS | 0x03 |

For example, in the example where the associated access type of the third apparatus 203 (for example, a non-3GPP device) indicating a non-3GPP access, the access type distinguisher may be set to the value for “non-3GPP access” when deriving KWAGF. In the example where the associated access type of the third apparatus 203 (for example, an AUN3 device) indicating a non-3GPP access without NAS, the access type distinguisher may be set to the value for “non-3GPP access without NAS” for example 0x03 when deriving KWAGF.

It is to be understood that the above parameters for generating (313) the first key and their corresponding values are only for the purpose of illustration, without suggesting any limitations. Any suitable approaches for determining the apparatus key may be applied. For example, an additional parameter L0 representing the length of device distinguisher with value (for example 0x00, 0x04 etc.) may be applied. In addition, an additional parameter P0 representing Device distinguisher (may be set to 0x01 for AUN3 device, otherwise it will be set to 0x00) may be applied.

The second apparatus 202 transmits (316) a first message to the first apparatus 201 to indicate that the third apparatus 203 is authenticated. For example, the second apparatus 202 may determine that the authentication procedure 310 for the third apparatus 203 succeeds. Based on the determination of the success authentication of the third apparatus 203, the second apparatus 202 transmits (316) the first message to the first apparatus. The first message may include an authentication succuss message such as an EAP success message to indicate the success authentication of the third apparatus. For example, the first message may be in a NAS security mode command mode with null security algorithm, such as N2 message-NAS Security Mode command (Null security algo, [EAP-Success]). It is to be understood that the example of first message is only for the purpose of illustration, without suggesting any limitations. Any suitable first message may be applied.

The first apparatus 201 receives (319) the first message. The first apparatus 201 may store (322) the first message or alternatively store the EAP success message included in the first message.

In some example embodiments, the first apparatus 201 may transmit (325) a second message to the second apparatus 202 to indicate completion of the security mode. For example, based on the receipt (319) of the first message, or alternatively based on the storing (322) of the first message, the first apparatus 201 may transmit (325) the second message. An example of the second message may include N2 message NAS security mode complete. It is to be understood that the example of second message is only for the purpose of illustration, without suggesting any limitations. Any suitable second message may be applied.

In some example embodiments, the second apparatus 202 may receive (328) the second message. Based on the receipt of the second message, the second apparatus 202 may transmit (331) the first key to the first apparatus 201. The first key may be generated (313) by the second apparatus 202. For example, the second apparatus 202 may transmit a N2 Initial Ctx setup request or other suitable information with the first key KWAGF to the first apparatus 201.

In some example embodiments, the first apparatus 201 may receive (334) the first key such as KWAGF. The first apparatus 201 may generate (337) the security information for the third apparatus 203 based on the first key such as KWAGF. For example, the security information may include a key for the third apparatus 203 such as a pairwise master key (PMK) for the third apparatus 203.

In some example embodiments, the first apparatus 201 may use a KDF to generate (337) the PMK for the third apparatus 203 (referred to as KAUN3) based on the first key KWAGF. For example, the first apparatus 201 may input the following parameters in the input S to the KDF:

$$FC = 0 x 〈 to be defined 〉 ;$$

$$P 0 = Usage type distinguisher ( i . e . , 0 x 01 ) ;$$

$$L 0 = length of Usage type distinguisher ( i . e . , 0 x 00 , 0 x 01 ) .$$

It is to be understood that the above parameters for generating (337) the security information such as the PMK and their corresponding values are only for the purpose of illustration, without suggesting any limitations. Any suitable approaches for determining the apparatus key may be applied.

The first apparatus 201 transmits (340), to the fourth apparatus 204, the security information such as the PMK for establishing a connection between the third apparatus 203 and fourth apparatus 204. Based on the receipt (319) of the first message, the first apparatus 201 transmits (340) the security information. For example, based on the receipt (319) of the first message, the first apparatus 201 may receive (334) the first key from the second apparatus 202, generate (337) the security information based on the first key, and transmit (340) the security information. In some example embodiments, the first apparatus 201 may transmit an authentication success message such as an EAP success message to the fourth apparatus 204 together with the security information. For example, the first apparatus 201 may transmit (EAP-Success, PMK) to the fourth apparatus 204.

The fourth apparatus 204 receives (343) the security information from the first apparatus 201. In some example embodiments, the fourth apparatus 204 may further receive the authentication success message such as EAP success message from the first apparatus 201 together with the security information. For example, the fourth apparatus 204 may receive for example (EAP-Success, PMK) from the first apparatus 201.

In some example embodiments, the fourth apparatus 204 may transmit (346) the authentication success message such as the EAP success message to the third apparatus 203. The third apparatus 203 may receive (349) the authentication success message such as an EAP notification or (EAP-Success) message.

In some example embodiments, the third apparatus 203 may generate (352) a key for communicating with the fourth apparatus. Likewise, the fourth apparatus 204 may generate (355) a same key for communicating with the third apparatus 203. For example, the same key may include a WLAN key.

In some example embodiments, the third apparatus 203 may generate (352) the key such as the WLAN key based on the associated access type of the third apparatus 203. For example, the third apparatus 203 may generate the PMK (or the KAUN3) based on the associated access type of the third apparatus 203 (for example, the non-3GPP access without NAS). The third apparatus may use a same KDF to generate the PMK. How to generate the PMK by using the KDF has been described above, which will not be repeated here.

The third apparatus 203 may generate (352) the WLAN key based on the PMK. In some example embodiments, the fourth apparatus 204 may generate (355) the key such as the WLAN key based on the received (343) security information such as the PMK (or the KAUN3).

The third apparatus 203 and the fourth apparatus 204 performs a procedure with each other to establish the connection based on the security information. The procedure may include a handshake procedure 358. For example, the third apparatus 203 and the fourth apparatus 204 may perform a handshake procedure 358 using the security information such as the PMK. The handshake procedure 358 may include a 4-way handshake. By performing the handshake procedure 358, the third apparatus 203 (for example, the AUN3 device can establish a secure connection with the WLAN AP (for example, the RG).

In some example embodiments, a secure connection 361 between the third apparatus 203 and the fourth apparatus 204 may be established. The secure connection may include a L2 connection or a layer 3 (L3) connection. Alternatively, or in addition, the first apparatus 201 may transmit (364) a N2 initial Ctx setup response to the second apparatus 202. For example, the N2 initial Ctx setup response may correspond to the N2 initial Ctx setup request received with the first key from the second apparatus 202. The second apparatus 202 may receive (367) the N2 initial Ctx setup response.

Example embodiments regarding authentication for the apparatus with non-cellular access have been described with respect to FIG. 3. In the example of FIG. 3, the EAP-AKA authentication procedure is used as an example of the authentication procedure. With such authentication for the apparatus with non-cellular access, the apparatus with non-cellular access such as the AUN3 device behind the RG connecting to the network can be identified, authorized and authenticated. In this way, security connection may be established, thus the communication security may be protected.

In addition, by using the present connection establishing process shown in the signaling chart 300, the network node's slice information may not be used in the authentication of the apparatus with non-cellular access. For example, the third apparatus may use the security information to generate the WLAN key for establishing the connection. The security information may be generated based on the associated access type of the third apparatus. Therefore, the network node's slice information may be protected. The network and the company owning the slice will be protected.

It is to be understood that the authentication procedure 237 and the authentication procedure 310 are only shown for the purpose of illustration, without suggesting any limitation of the scope. Any suitable authentication procedure may be applied in the authentication of the third apparatus. It is also to be understood that the signaling chart 200 in FIG. 2 and the signaling chart 300 in FIG. 3 are shown only for the purpose of illustration without suggesting any limitation. The signaling chart 200 or signaling chart 300 may include additional processes or actions not shown and/or may omit some shown processes or actions, and the scope of the present disclosure is not limited in this regard.

### Example Methods

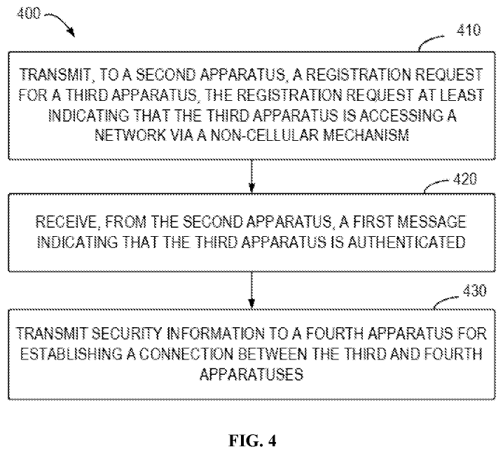

FIG. 4 shows a flowchart of an example method 400 implemented at a first apparatus in accordance with some example embodiments of the present disclosure. In some example embodiments, the first apparatus may include a network device such as the first apparatus 201 in FIG. 2 or the W-AGF 130 in FIG. 1. For the purpose of discussion, the method 400 will be described from the perspective of the first apparatus 201 in FIG. 2.

At block 410, the first apparatus 201 transmits, to a second apparatus 202, a registration request for a third apparatus 203. The registration request at least indicates that the third apparatus 203 is accessing a network via a non-cellular mechanism. For example, the registration request may include an indication of a requirement for an encryption key for the third apparatus 203. Alternatively, or in addition, the registration request may include an indication of an apparatus type of the third apparatus 203.

At block 420, the first apparatus 201 receives, from the second apparatus 202, a first message indicating that the third apparatus 203 is authenticated. In some example embodiments, the first message may further include the security information. For example, the security information may include a session key for the third apparatus 203, such as a master session key, or an extended master session key

At block 430, based on the receipt of the first message, the first apparatus 201 transmits security information to a fourth apparatus 204 for establishing a connection between the third apparatus 203 and fourth apparatus 204.

In some example embodiments, the first message may further include a request for a security mode. In such cases, based on the receipt of the first message, the first apparatus 201 may transmit a second message to the second apparatus 202 to indicate completion of the security mode. The first apparatus 201 may receive a first key for the first apparatus 201 from the second apparatus 202. The first key may be determined by the second apparatus 202 based on an access type associated with the non-cellular mechanism. The first apparatus 201 may generate the security information based on the first key. For example, the security information may include a pairwise master key for the third apparatus 203.

In some example embodiments, the first apparatus 202 may receive, from the third apparatus 203 or the fourth apparatus 204, a third message at least indicating that the third apparatus 203 is accessing the network via the non-cellular mechanism. In addition, the first apparatus 202 may generate the registration request based on the third message.

In some example embodiments, the third message and the registration request may further indicate an identification of the third apparatus 203, respectively. For example, the identification of the third apparatus 203 may include at least one of the following: a subscription concealed identifier, an identifier in a network access identifier format, or an identifier in a global unique temporary identifier format.

In some example embodiments, the first apparatus 201 may include a wireline access gateway function, the second apparatus 202 may include an access and mobility management function or a security anchor function, the third apparatus 203 may include an authenticable non-3rd generation partnership project device, and the fourth apparatus 204 may include a residential gateway.

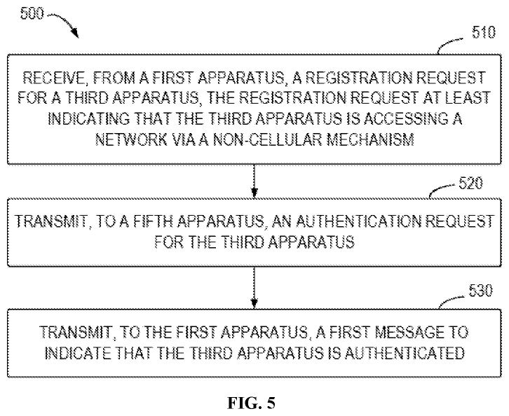

FIG. 5 shows a flowchart of an example method 500 implemented at a second apparatus in accordance with some example embodiments of the present disclosure. In some example embodiments, the second apparatus may include a network device such as the AMF 140 or SEAF 145 in FIG. 1 or the second apparatus 202 in FIG. 2. For the purpose of discussion, the method 500 will be described from the perspective of the second apparatus 202 in FIG. 2.

At block 510, the second apparatus 202 receives, from a first apparatus 201, a registration request for a third apparatus 203. The registration request at least indicates that the third apparatus 203 is accessing a network via a non-cellular mechanism. For example, the registration request may include an indication of a requirement for an encryption key for the third apparatus 203. Alternatively, or in addition, the registration request may include an indication of an apparatus type of the third apparatus 203.

At block 520, the second apparatus 202 transmits, to a fifth apparatus 205, an authentication request for the third apparatus. The authentication request at least indicates that the third apparatus is accessing the network via the non-cellular mechanism.

At block 530, the second apparatus 202 transmits, to the first apparatus 201, a first message to indicate that the third apparatus 203 is authenticated. In some example embodiments, at block 530, the second apparatus 202 may determine that an authentication procedure for the third apparatus 203 succeeds. Based on the determination that the authentication procedure succeeds, the second apparatus 202 transmits the first message.

In some example embodiments, the second apparatus 202 further receives an authentication response to the authentication request from the fifth apparatus 205. The authentication response may indicate that the third apparatus is authenticated. The authentication response may include security information for the third apparatus 203. In such cases, the first message may further include the security information.

Alternatively, or in addition, the first message may further include a request for a security mode. In such cases, the second apparatus 202 may further generate a first key for the first apparatus based on an access type associated with the non-cellular mechanism. The second apparatus 202 may further receive, from the first apparatus 202, a second message indicating completion of the security mode. Based on the receipt of the second message, the second apparatus 202 may further transmit the first key to the first apparatus 201.

In some example embodiments, the first apparatus 201 may include a wireline access gateway function, the second apparatus 202 may include an access and mobility management function or a security anchor function, the third apparatus 203 may include an authenticable non-3rd generation partnership project device, and the fifth apparatus 205 may include an authentication server function.

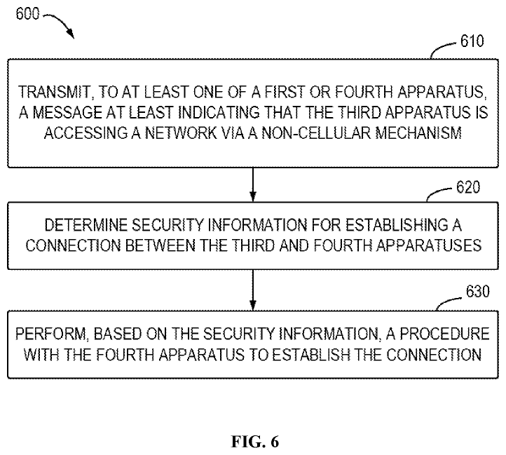

FIG. 6 shows a flowchart of an example method 600 implemented at a third apparatus in accordance with some example embodiments of the present disclosure. For example, the third apparatus may include a terminal device such as the terminal device 110 in FIG. 1 or the third apparatus 203 in FIG. 2. For the purpose of discussion, the method 600 will be described from the perspective of the third apparatus 203 in FIG. 2.

At block 610, the third apparatus 203 transmits, to at least one of a first apparatus 201 or a fourth apparatus 204, a message at least indicating that the third apparatus 203 is accessing a network via a non-cellular mechanism. For example, the third apparatus 203 may transmit the message to the first apparatus 201. Alternatively, or in addition, the third apparatus 203 may transmit the message to the fourth apparatus 204. In some example embodiments, the message may further indicate an identification of the third apparatus 203. For example, the identification of the third apparatus may include at least one of the following: a subscription concealed identifier, an identifier in a network access identifier format, or an identifier in a global unique temporary identifier format.

At block 620, the third apparatus 203 determines security information for establishing a connection between the third apparatus 203 and fourth apparatus 204. For example, the third apparatus 203 may determine the security information based on a credential for the third apparatus 203. Alternatively, or in addition, in some example embodiments, the third apparatus 203 may determine the security information at least in part based on an access type associated with the non-cellular mechanism.

In some example embodiments, the security information may include one of the following: a session key for the third apparatus, or a pairwise master key for the third apparatus. For example, the session key may include one of the following: a master session key, or an extended master session key.

At block 630, the third apparatus 203 performs, based on the security information, a procedure with the fourth apparatus 204 to establish the connection.

In some example embodiments, the third apparatus 203 may further generate, based on the security information, a key for communicating with the fourth apparatus 204.

In some example embodiments, the third apparatus 203 may include an authenticable non-3rd generation partnership project device, and the fourth apparatus may include a residential gateway.

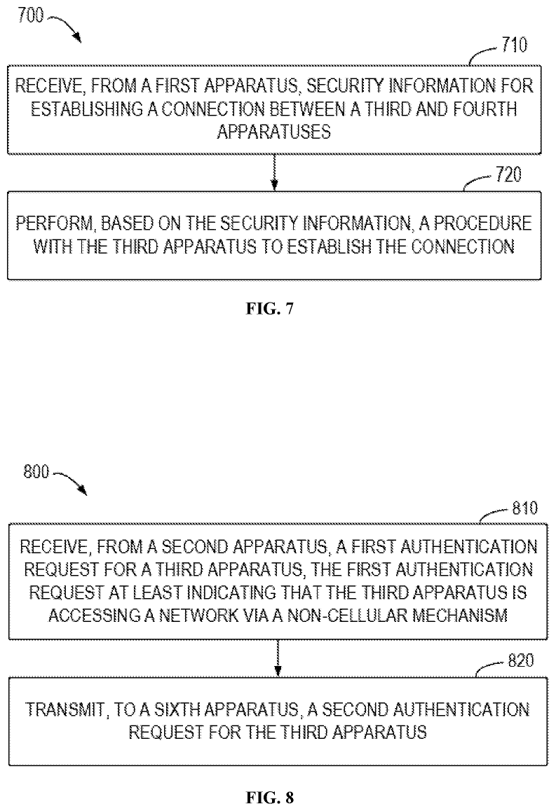

FIG. 7 shows a flowchart of an example method 700 implemented at a fourth apparatus in accordance with some example embodiments of the present disclosure. For example, the fourth apparatus may include a network device such as the RG 120 in FIG. 1 or the fourth apparatus 204 in FIG. 2. For the purpose of discussion, the method 700 will be described from the perspective of the fourth apparatus 204 in FIG. 2.

At block 710, the fourth apparatus 204 receives from a first apparatus 201, security information for establishing a connection between a third apparatus 203 and the fourth apparatus 204.

At block 720, the fourth apparatus 104 performs, based on the security information, a procedure with the third apparatus 203 to establish the connection.

In some example embodiments, the fourth apparatus 204 may further generate, based on the security information, a key for communicating with the third apparatus 203.

In some example embodiments, the fourth apparatus 204 may further receive, from the third apparatus 203, a first message at least indicating that the third apparatus 203 is accessing a network via a non-cellular mechanism. Based on the receipt of the first message, the fourth apparatus 204 may transmit, to the first apparatus 201, a second message at least indicating that the third apparatus 203 is accessing the network via the non-cellular mechanism.

In some example embodiments, the first apparatus 201 may include a wireline access gateway function, the third apparatus 203 may include an authenticable non-3rd generation partnership project device, and the fourth apparatus 204 may include a residential gateway.

FIG. 8 shows a flowchart of an example method 800 implemented at a fifth apparatus in accordance with some example embodiments of the present disclosure. In some example embodiments, the fifth apparatus may include a network device such as the AUSF 150 in FIG. 1 or the fifth apparatus 205 in FIG. 2. For the purpose of discussion, the method 800 will be described from the perspective of the fifth apparatus 205 in FIG. 2.

At block 810, the fifth apparatus 205 receives, from a second apparatus 202, a first authentication request for a third apparatus 203. The first authentication request at least indicates that the third apparatus 203 is accessing a network via a non-cellular mechanism.

At block 820, the fifth apparatus 205 transmits, to a sixth apparatus 206, a second authentication request for the third apparatus 203. In some example embodiments, the second authentication request may indicate that the third apparatus 203 is accessing the network via the non-cellular mechanism.

In some example embodiments, the fifth apparatus 205 further generate security information for the third apparatus 203 based on a credential for the third apparatus 203. The fifth apparatus 205 may determine that the third apparatus 203 is authenticated based on an authentication procedure initiated by the sixth apparatus 206. Based on the determination that the third apparatus 203 is authenticated, the fifth apparatus 205 may transmit, to the second apparatus 202, an authentication response indicating that the third apparatus 203 is authenticated and comprising the security information.

In some example embodiments, the security information may include a session key for the third apparatus 203. For example, the session key may include one of the following: a master session key, or an extended master session key.

In some example embodiments, the authentication procedure may include one of the following: an extensible authentication protocol-transport level security procedure, an extensible authentication protocol-authentication and key agreement procedure, or a 5th generation mobile communication technology authentication and key agreement procedure.

In some example embodiments, the second apparatus 202 may include an access and mobility management function or a security anchor function, the third apparatus 203 may include an authenticable non-3rd generation partnership project device, the fifth apparatus 205 may include an authentication server function, and the sixth apparatus 206 may include a unified data management.

It is to be understood that the method 400, the method 500, the method 600, the method 700 or the method 800 may include additional blocks not shown and/or may omit some shown blocks, and the scope of the present disclosure is not limited in this regard.

### Example Apparatus, Device and Medium

In some example embodiments, a first apparatus capable of performing any of the method 400 (for example, the first apparatus 201 in FIG. 2) may include means for performing the respective operations of the method 400. The means may be implemented in any suitable form. For example, the means may be implemented in a circuitry or software module. The first apparatus may be implemented as or included in the first apparatus 201 in FIG. 2.

In some example embodiments, the first apparatus includes means for transmitting, to a second apparatus, a registration request for a third apparatus, the registration request at least indicating that the third apparatus is accessing a network via a non-cellular mechanism: means for receiving, from the second apparatus, a first message indicating that the third apparatus is authenticated; and means for based on the receipt of the first message, transmitting security information to a fourth apparatus for establishing a connection between the third and fourth apparatuses.

In some example embodiments, the registration request may include an indication of a requirement for an encryption key for the third apparatus. Alternatively, or in addition, the registration request may include an indication of an apparatus type of the third apparatus.

In some example embodiments, the first message may further include the security information. For example, the security information may include a session key for the third apparatus, such as at least one of a master session key, or an extended master session key

In some example embodiments, the first message may further include a request for a security mode. In such cases, the first apparatus may further include means for based on the receipt of the first message, transmitting a second message to the second apparatus to indicate completion of the security mode: means for receiving, from the second apparatus, a first key for the first apparatus, the first key determined by the second apparatus based on an access type associated with the non-cellular mechanism; and means for generating the security information based on the first key. For example, the security information may include a pairwise master key for the third apparatus.

In some example embodiments, the first apparatus may further include means for receiving from the third or fourth apparatus, a third message at least indicating that the third apparatus is accessing the network via the non-cellular mechanism. In addition, the first apparatus may further include means for generating the registration request based on the third message.

In some example embodiments, the third message and the registration request may further indicate an identification of the third apparatus, respectively. For example, the identification of the third apparatus may include at least one of the following: a subscription concealed identifier, an identifier in a network access identifier format, or an identifier in a global unique temporary identifier format.

In some example embodiments, the first apparatus further comprises means for performing other operations in some example embodiments of the method 400 or the first apparatus 201. In some example embodiments, the means comprises at least one processor; and at least one memory storing instructions that, when executed by the at least one processor, cause the performance of the first apparatus.

In some example embodiments, a second apparatus capable of performing any of the method 500 (for example, the second apparatus 202 in FIG. 2) may comprise means for performing the respective operations of the method 500. The means may be implemented in any suitable form. For example, the means may be implemented in a circuitry or software module. The second apparatus may be implemented as or included in the second apparatus 202 in FIG. 2.

In some example embodiments, the second apparatus includes: means for receiving, from a first apparatus, a registration request for a third apparatus, the registration request at least that the third apparatus is accessing a network via a non-cellular mechanism; means for transmitting, to a fifth apparatus, an authentication request for the third apparatus, the authentication request at least indicating that the third apparatus is accessing the network via the non-cellular mechanism; and means for transmitting, to the first apparatus, a first message to indicate that the third apparatus is authenticated.

For example, the registration request may include at least one of the following: an indication of a requirement for an encryption key for the third apparatus, or an indication of an apparatus type of the third apparatus.

In some example embodiments, the means for transmitting the first message may further include means for determining that an authentication procedure for the third apparatus succeeds; and means for based on the determination that the authentication procedure succeeds, transmitting the first message.

In some example embodiments, the second apparatus may further include means for receiving an authentication response to the authentication request from the fifth apparatus. The authentication response may indicate that the third apparatus is authenticated. The authentication response may include security information for the third apparatus. In such cases, the first message may further include the security information.

Alternatively, or in addition, the first message may further include a request for a security mode. In such cases, the second apparatus may further include means for generating a first key for the first apparatus based on an access type associated with the non-cellular mechanism; means for receiving, from the first apparatus, a second message indicating completion of the security mode; and means for based on the receipt of the second message, transmitting the first key to the first apparatus.

In some example embodiments, the second apparatus further comprises means for performing other operations in some example embodiments of the method 500 or the second apparatus 202. In some example embodiments, the means comprises at least one processor; and at least one memory storing instructions that, when executed by the at least one processor, cause the performance of the second apparatus.

In some example embodiments, a third apparatus capable of performing any of the method 600 (for example, the third apparatus 203 in FIG. 2) may comprise means for performing the respective operations of the method 600. The means may be implemented in any suitable form. For example, the means may be implemented in a circuitry or software module. The third apparatus may be implemented as or included in the third apparatus 203 in FIG. 2.

In some example embodiments, the third apparatus includes: means for transmitting, to at least one of a first or fourth apparatus, a message at least indicating that the third apparatus is accessing a network via a non-cellular mechanism; means for determining security information for establishing a connection between the third and fourth apparatuses; and means for performing, based on the security information, a procedure with the fourth apparatus to establish the connection.

In some example embodiments, the message may further indicate an identification of the third apparatus. For example, the identification of the third apparatus may include at least one of the following: a subscription concealed identifier, an identifier in a network access identifier format, or an identifier in a global unique temporary identifier format.

In some example embodiments, the means for determining security information may include means for determining the security information based on a credential for the third apparatus. Alternatively, or in addition, the means for determining security information may include means for determining the security information at least in part based on an access type associated with the non-cellular mechanism. In such cases, the means for determining security information may include means for determining the security information at least in part based on the associated access type.

In some example embodiments, the security information may include one of the following: a session key for the third apparatus, or a pairwise master key for the third apparatus. For example, the session key may include one of the following: a master session key, or an extended master session key.

In some example embodiments, the third apparatus may further include means for generating, based on the security information, a key for communicating with the fourth apparatus.

In some example embodiments, the third apparatus further comprises means for performing other operations in some example embodiments of the method 600 or the third apparatus 203. In some example embodiments, the means comprises at least one processor; and at least one memory storing instructions that, when executed by the at least one processor, cause the performance of the third apparatus.

In some example embodiments, a fourth apparatus capable of performing any of the method 700 (for example, the fourth apparatus 204 in FIG. 2) may comprise means for performing the respective operations of the method 700. The means may be implemented in any suitable form. For example, the means may be implemented in a circuitry or software module. The fourth apparatus may be implemented as or included in the fourth apparatus 204 in FIG. 2.

In some example embodiments, the fourth apparatus includes: means for receiving, from a first apparatus, security information for establishing a connection between a third apparatus and the fourth apparatus; and means for performing, based on the security information, a procedure with the third apparatus to establish the connection.

In some example embodiments, the fourth apparatus may further include means for generating, based on the security information, a key for communicating with the third apparatus.

In some example embodiments, the fourth apparatus may further include means for receiving, from the third apparatus, a first message at least indicating that the third apparatus is accessing a network via a non-cellular mechanism; and means for based on the receipt of the first message, transmitting, to the first apparatus, a second message at least indicating that the third apparatus is accessing the network via the non-cellular mechanism.

In some example embodiments, the fourth apparatus further comprises means for performing other operations in some example embodiments of the method 700 or the fourth apparatus 204. In some example embodiments, the means comprises at least one processor; and at least one memory storing instructions that, when executed by the at least one processor, cause the performance of the fourth apparatus.

In some example embodiments, a fifth apparatus capable of performing any of the method 800 (for example, the fifth apparatus 205 in FIG. 2) may comprise means for performing the respective operations of the method 800. The means may be implemented in any suitable form. For example, the means may be implemented in a circuitry or software module. The fifth apparatus may be implemented as or included in the fifth apparatus 205 in FIG. 2.

In some example embodiments, the fifth apparatus includes: means for receiving, from a second apparatus, a first authentication request for a third apparatus, the first authentication request at least indicating that the third apparatus is accessing a network via a non-cellular mechanism; and means for transmitting, to a sixth apparatus, a second authentication request for the third apparatus. In some example embodiments, the second authentication request may indicate that the third apparatus is accessing the network via the non-cellular mechanism.

In some example embodiments, the fifth apparatus may further include means for generating security information for the third apparatus based on a credential for the third apparatus: means for determining that the third apparatus is authenticated based on an authentication procedure initiated by the sixth apparatus; and means for based on the determination that the third apparatus is authenticated, transmitting, to the second apparatus, an authentication response indicating that the third apparatus is authenticated and comprising the security information.

In some example embodiments, the security information may include a session key for the third apparatus. For example, the session key may include one of the following: a master session key, or an extended master session key.

In some example embodiments, the authentication procedure may include one of the following: an extensible authentication protocol-transport level security procedure, an extensible authentication protocol-authentication and key agreement procedure, or a 5th generation mobile communication technology authentication and key agreement procedure.

In some example embodiments, the fifth apparatus further comprises means for performing other operations in some example embodiments of the method 800 or the fifth apparatus 205. In some example embodiments, the means comprises at least one processor; and at least one memory storing instructions that, when executed by the at least one processor, cause the performance of the fifth apparatus.

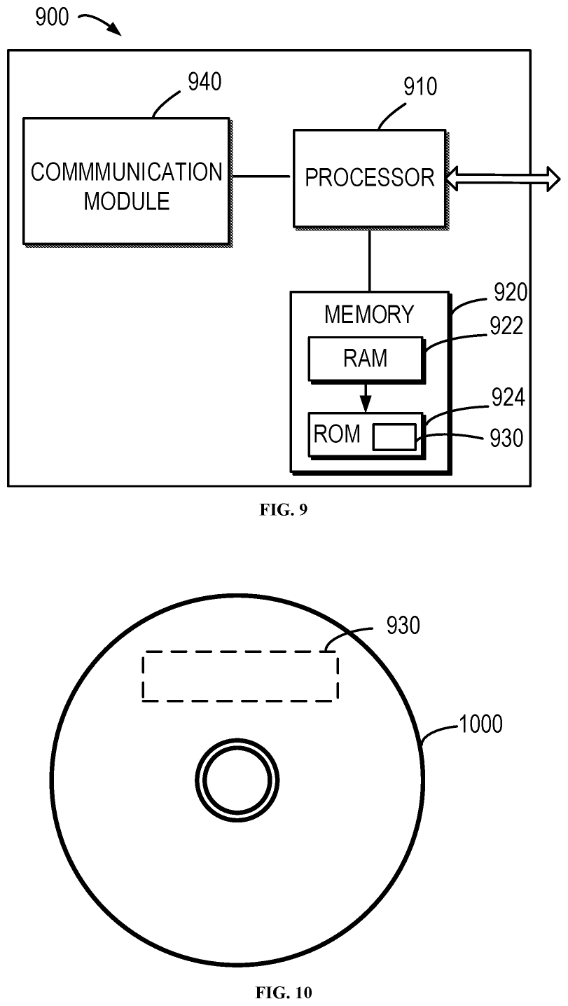

FIG. 9 is a simplified block diagram of a device 900 that is suitable for implementing example embodiments of the present disclosure. The device 900 may be provided to implement a communication device, for example, the terminal device 110, the RG 120, the W-AGF 130, the AMF 140, the SEAF 145, the AUSF 150 or the UDM 160 as shown in FIG. 1, or the first apparatus 201, the second apparatus 202, the third apparatus 203, the fourth apparatus 204, the fifth apparatus 205 or the sixth apparatus 206 as shown in FIG. 2. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-43. (canceled)

44. A first apparatus comprising:
at least one processor; and
at least one memory storing instructions that, when executed by the at least one processor, cause the first apparatus at least to perform:
transmitting, to a second apparatus, a registration request for a third apparatus, the registration request at least indicating that the third apparatus is accessing a network via a non-cellular mechanism;
receiving, from the second apparatus, a first message indicating that the third apparatus is authenticated; and
based on the receipt of the first message, transmitting security information to a fourth apparatus for establishing a connection between the third and fourth apparatuses.

45. The first apparatus of claim 44, wherein the first message further comprises a request for a security mode, and
wherein the first apparatus is further caused to perform:
based on the receipt of the first message, transmitting a second message to the second apparatus to indicate completion of the security mode;
receiving, from the second apparatus, a first key for the first apparatus, the first key determined by the second apparatus based on an access type associated with the non-cellular mechanism; and
generating the security information based on the first key.

46. The first apparatus of claim 44, wherein:
the first apparatus comprises a wireline access gateway function,
the second apparatus comprises an access and mobility management function or a security anchor function,
the third apparatus comprises an authenticable non-3rd generation partnership project device, and
the fourth apparatus comprises a residential gateway.

47. A second apparatus comprising:
at least one processor; and
at least one memory storing instructions that, when executed by the at least one processor, cause the second apparatus at least to perform:
receiving, from a first apparatus, a registration request for a third apparatus, the registration request at least that the third apparatus is accessing a network via a non-cellular mechanism;
transmitting, to a fifth apparatus, an authentication request for the third apparatus, the authentication request at least indicating that the third apparatus is accessing the network via the non-cellular mechanism; and
transmitting, to the first apparatus, a first message to indicate that the third apparatus is authenticated.

48. The second apparatus of claim 47, wherein:
the first apparatus comprises a wireline access gateway function,
the second apparatus comprises an access and mobility management function or a security anchor function,
the third apparatus comprises an authenticable non-3rd generation partnership project device, and
the fifth apparatus comprises an authentication server function.

49. A third apparatus comprising:
at least one processor; and
at least one memory storing instructions that, when executed by the at least one processor, cause the third apparatus at least to perform:
transmitting, to at least one of a first or fourth apparatus, a message at least indicating that the third apparatus is accessing a network via a non-cellular mechanism;
determining security information for establishing a connection between the third and fourth apparatuses; and
performing, based on the security information, a procedure with the fourth apparatus to establish the connection.

50. The third apparatus of claim 49, wherein the third apparatus is further caused to perform:
generating, based on the security information, a key for communicating with the fourth apparatus.

51. The third apparatus of claim 49, wherein determining the security information comprises at least one of the following:
determining the security information based on a credential for the third apparatus; or
determining the security information at least in part based on an access type associated with the non-cellular mechanism.

52. The third apparatus of claim 49, wherein the message further indicates an identification of the third apparatus.

53. The third apparatus of claim 52, wherein the identification of the third apparatus comprises at least one of the following:
a subscription concealed identifier,
an identifier in a network access identifier format, or
an identifier in a global unique temporary identifier format.

54. The third apparatus of claim 49, wherein the security information comprises one of the following:
a session key for the third apparatus, or
a pairwise master key for the third apparatus.

55. The third apparatus of claim 54, wherein the session key comprises one of the following:
a master session key, or
an extended master session key.

56. The third apparatus of claim 49, wherein the third apparatus comprises an authenticable non-3rd generation partnership project device, and the fourth apparatus comprises a residential gateway.

57. A fourth apparatus comprising:
at least one processor; and
at least one memory storing instructions that, when executed by the at least one processor, cause the fourth apparatus at least to perform:
receiving, from a first apparatus, security information for establishing a connection between a third apparatus and the fourth apparatus; and
performing, based on the security information, a procedure with the third apparatus to establish the connection.

58. The fourth apparatus of claim 57, wherein the fourth apparatus is further caused to perform:
receiving, from the third apparatus, a first message at least indicating that the third apparatus is accessing a network via a non-cellular mechanism; and
based on the receipt of the first message, transmitting, to the first apparatus, a second message at least indicating that the third apparatus is accessing the network via the non-cellular mechanism.

59. The fourth apparatus of claim 57, wherein:
the first apparatus comprises a wireline access gateway function,
the third apparatus comprises an authenticable non-3rd generation partnership project device, and
the fourth apparatus comprises a residential gateway.

60. A fifth apparatus comprising:
at least one processor; and
at least one memory storing instructions that, when executed by the at least one processor,
cause the fifth apparatus at least to perform:
receiving, from a second apparatus, a first authentication request for a third apparatus, the first authentication request at least indicating that the third apparatus is accessing a network via a non-cellular mechanism; and
transmitting, to a sixth apparatus, a second authentication request for the third apparatus.

61. The fifth apparatus of claim 60, wherein the fifth apparatus is further caused to perform:
generating security information for the third apparatus based on a credential for the third apparatus;
determining that the third apparatus is authenticated based on an authentication procedure initiated by the sixth apparatus; and
based on the determination that the third apparatus is authenticated, transmitting, to the second apparatus, an authentication response indicating that the third apparatus is authenticated and comprising the security information.

62. The fifth apparatus of claim 60, wherein:
the second apparatus comprises an access and mobility management function or a security anchor function,
the third apparatus comprises an authenticable non-3rd generation partnership project device,
the fifth apparatus comprises an authentication server function, and
the sixth apparatus comprises a unified data management.
